(19) United States
(12) Patent Application Publication
(10) Pub. No.: US 2025/0036008 A1
(43) Pub. Date: Jan. 30, 2025

(54) DOME COVER AND CAMERA INCLUDING THE SAME

(71) Applicant: HANWHA VISION CO., LTD., Seongnam-si (KR)

(72) Inventors: Dae Kyung KIM, Seongnam-si (KR); Kil Hwa HONG, Seongnam-si (KR)

(73) Assignee: HANWHA VISION CO., LTD., Seongnam-si (KR)

(21) Appl. No.: 18/779,795

(22) Filed: Jul. 22, 2024

(30) Foreign Application Priority Data
Jul. 28, 2023 (KR) 10-2023-0098985
Jun. 14, 2024 (KR) 10-2024-0077519

(51) Int. Cl. G03B 11/04

(52) U.S. Cl. CPC G03B 11/045

(57) ABSTRACT

A dome cover configured to shield an opening of a housing in which at least one camera module and a light module corresponding to the at least one camera module are mounted, the dome cover includes: a light cover coupled to the housing and surrounding an outside of the light module; a camera cover surrounding the outside of the at least one camera module and shielding the opening of the housing; and a shield interposed between the light cover and the camera cover and configured to prevent transmission of light from the light module, wherein the light cover and the camera cover are attached to the shielding member.

This application claims the benefit of Korean Patent Application No. 10-2023-0098985, filed on Jul. 28, 2023, and No. 10-2024-0077519, filed on Jun. 14, 2024, in the Korean Intellectual Property Office, the disclosure of which is incorporated herein in its entirety by reference.

### BACKGROUND

### 1. Field

The present disclosure relates to a dome cover and a camera including the same, and more particularly, to a dome cover including a light cover member, a camera cover and a shielding member, and a camera including the dome cover.

### 2. Description of Related Art

In general, surveillance cameras for monitoring a specific area include a plurality of camera modules having pan/tilt/zoom motions to cover a wide area with a small number of devices and track objects with specific movements. In particular, among various types of surveillance cameras, dome cameras are increasingly used because they are easy to pan/tilt/zoom and can be miniaturized due to their circularly symmetrical shape with respect to a central axis.

A surveillance camera includes a dome cover provided to cover a plurality of cameras as a transparent optical outer component and is configured to prevent fogging or condensation of the dome cover by sending air to an inner surface of the dome cover using a fan mounted on the inside of the dome cover. Specifically, a conventional dome camera has a plurality of blower fans and a plurality of intake and exhaust ports installed in the vicinity of a plurality of camera modules arranged in a circumferential direction of a housing.

The blower fans may be used to remove moisture generated by a temperature difference between the inside and outside of the camera device or may be used to cool the camera modules or a circuit board that may be overheated depending on the installation or use environments.

In addition, the dome cover includes a transparent panel that transmits reflected light from a subject so that the reflected light can enter a camera module and a transmissive panel that transmits infrared rays irradiated from a light module. Because the transmissive panel of the light module and the transparent panel of the dome cover are formed of different materials or shapes, they are manufactured as separate elements and then assembled and mounted on the housing.

However, the dome cover used in a conventional surveillance camera requires an intermediate injection-molded product for assembling the transparent panel and the transmissive panel and requires a fastening structure for assembling the panels on both sides to the intermediate injection-molded product and a space for providing the fastening structure. Therefore, the product size inevitably increases, and additional time and cost are incurred due to the assembly process.

### SUMMARY

Provided is a dome cover and a camera including the same, in which a light cover and a camera cover are formed integrally with a shield therebetween without an assembly process, and light emitted from the light cover can be prevented from entering the camera cover member.

Aspects of the present disclosure are not restricted to the one set forth herein. The above and other aspects of the present disclosure will become more apparent to one of ordinary skill in the art to which the present disclosure pertains by referencing the detailed description of the present disclosure given below.

According to an aspect of the present disclosure, a dome cover configured to shield an opening of a housing in which at least one camera module and a light module corresponding to the at least one camera module are mounted, the dome cover includes: a light cover coupled to the housing and surrounding an outside of the light module; a camera cover surrounding the outside of the at least one camera module and shielding the opening of the housing; and a shield interposed between the light cover and the camera cover and configured to prevent transmission of light from the light module. The light cover and the camera cover may be attached to the shielding member.

The shield may include: a fixing portion having a fixing groove formed on a first side, that the fixing groove may be configured to allow at least a portion of a tip end of the camera cover to be inserted therein, and the light cover may be attached to a second side; and an extension portion extending from an inner circumferential surface of the fixing portion toward an inner area of the light cover member.

The light cover may be molded by double injection and the light cover may be attached to a tip end of the second side of the fixing portion.

The camera cover may be molded by ultrasonic welding and a portion of the camera cover inserted into the fixing groove is attached to the first side of the fixing portion.

The extension portion may include a reflection pattern on an outer surface facing an inner circumferential surface of the light cover and may be configured to reflect light irradiated from the light module toward the light cover member.

The shield may include a winkle pattern on a surface of the first side of the fixing portion.

The shield may include an eave protruding from an outer surface of the fixing portion along a circumferential direction.

An outer circumferential surface of the eave may protrude further outward than an outer circumferential surface of the fixing portion.

According to another aspect of the present disclosure, a dome cover configured to shield an opening of a housing in which at least one camera module and a light module corresponding to the at least one camera module are mounted, the dome cover includes: a light cover coupled to the housing and surrounding an outside of the light module; a camera cover surrounding the outside of the at least one camera module and shielding the opening of the housing; a shield interposed between the light cover and the camera cover and configured to prevent transmission of light from the light module; and an eave coupled to the shield and configured to prevent light emitted from the light cover from being incident toward the camera cover member.

The shield may include: a fixing portion including a fixing groove and a coupling groove formed on a first side, the light cover may be attached to a second side of the fixing portion; and an extension portion extending from an inner circumferential surface of the fixing portion toward an inner area of the light cover member. The camera cover may be attached to the fixing groove, and the coupling groove, into which the eave is inserted, may be formed outside the fixing groove.

The eave may include: a coupling portion protruding from a lower surface of the eave and inserted into the coupling groove; a wrinkle pattern protruding from an upper surface of the eave in a set pattern along a circumferential direction; and a protruding portion protruding further outward from an outer circumferential surface of the eave than an outer circumferential surface of the fixing portion.

The eave may slope upward such that a height of the protruding portion increases from the inside toward the outside.

The protruding portion may be configured to interfere with an imaginary straight line that connects a light emission surface of the light cover to an outer surface of the camera cover member.

The light cover and the camera cover may be attached to both sides of the shielding member.

The light cover may be formed by double injection and the light cover is attached to a tip end of the second side of the fixing portion.

A tip end of the camera cover and the fixing groove may be attached by ultrasonic welding, and the coupling portion and the coupling groove may be attached by ultrasonic welding.

The camera cover may be attached inside the light cover to the shielding member.

The extension portion may include a reflection pattern on an outer surface facing an inner circumferential surface of the light cover and may be configured to reflect light irradiated from the light module toward the light cover member.

According to another aspect of the present disclosure, a camera including: a fixed stage; at least one camera module on the fixed stage; a light module corresponding to the at least one camera module; a bracket coupled onto the fixed stage and configured to simultaneously rotate the at least one camera module and the light module about one rotation axis; and a dome cover on the fixed stage and configured to cover the at least one camera module and the light module. The dome cover includes: a light cover surrounding the outside of the light module; a camera cover surrounding the outside of the at least one camera module; a shield interposed between the light cover and the camera cover and configured to block light from the light module from being transmitted to the camera cover member; and an eave coupled to the shield and configured to prevent light emitted from the light cover from being incident toward the camera cover member.

The eave may include a protruding portion protruding further outward than an outer circumferential surface of the shielding member and may be configured to interfere with an imaginary straight line that connects a light emission surface of the light cover to an outer surface of the camera cover member.

### BRIEF DESCRIPTION OF DRAWINGS

The foregoing summary, as well as the detailed description of the exemplary embodiments of the present disclosure, will be better understood when read in conjunction with the appended drawings. For the purpose of illustrating the disclosure, there is shown in the drawings, which are diagrammatic, embodiments that are presently preferred. It should be understood, however, that the present disclosure is not limited to the precise arrangements and instrumentalities shown. In the drawings:

FIG. 1 is a perspective view of a camera to which a dome cover is coupled according to some embodiments of the present disclosure;

FIG. 2 is an exploded perspective view of the camera shown in FIG. 1;

FIG. 3 is a cross-sectional view of the camera taken along line I-I′ of FIG. 1;

FIG. 4 is an enlarged cross-sectional view of a portion of the dome cover shown in FIG. 3;

FIG. 5 is a partial enlarged view of area A of FIG. 4;

FIG. 6 is a reference diagram of the dome cover according to some embodiments of the present disclosure; and

FIG. 7 is a reference diagram the dome cover according to some embodiments of the present disclosure.

### DETAILED DESCRIPTION

Exemplary embodiments of the present disclosure will now be described in detail with reference to the accompanying drawings. Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. Like reference numerals refer to like elements throughout the specification.

The present disclosure may have various modifications and various embodiments, and thus specific embodiments are illustrated in the drawings and described in detail in the detailed description.

However, it should be understood that the present disclosure is not limited to specific embodiments and includes all modifications, equivalents or alternatives within the spirit and technical scope of the present disclosure.

Although the terms first, second, third, etc., may be used herein to describe various elements, these elements should not be limited by these terms.

These terms are only used to distinguish one element from another element.

For example, a second element could be termed a first element without departing from the scope of right of the present disclosure. Similarly, the first element could be termed the second element.

As used herein, the term “and/or” includes any and all combinations of one or more of the associated listed items. For example, the term “at least one of A, B or C” includes any and all combinations of A, B, or C alone and a group of A and B, A and C, B and C, and A, B, and C.

It will be understood that when an element is referred to as being “connected to” or “coupled to” another element, it can be directly connected or coupled to the other element or intervening elements may be present.

In contrast, when an element is referred to as being “directly connected to” or “directly coupled to” another element, there are no intervening elements present.

The terminology used herein is for the purpose of describing particular embodiments only and is not intended to be limiting of the invention.

As used herein, the singular forms “a”, “an” and “the” are intended to include the plural forms as well, unless the context clearly indicates otherwise.

It will be further understood that the terms “comprises” and/or “has,” when used in this specification, specify the presence of stated features, integers, steps, operations, elements, components, and/or combinations thereof, but do not preclude the presence or addition of one or more other features, integers, steps, operations, elements, components, and/or combinations thereof.

Hereinafter, various embodiments of the present disclosure will be described in detail with reference to the accompanying drawings. The same or corresponding elements will be identified by the same reference numerals regardless of numerals in the drawings, and any redundant description thereof will be omitted.

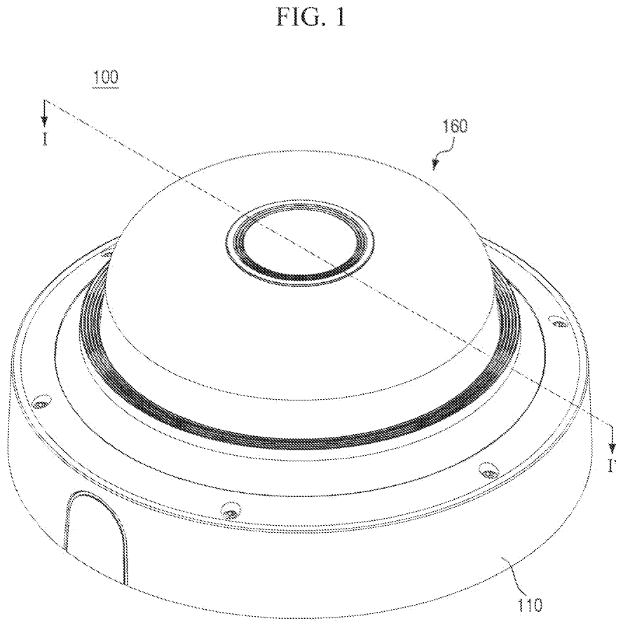

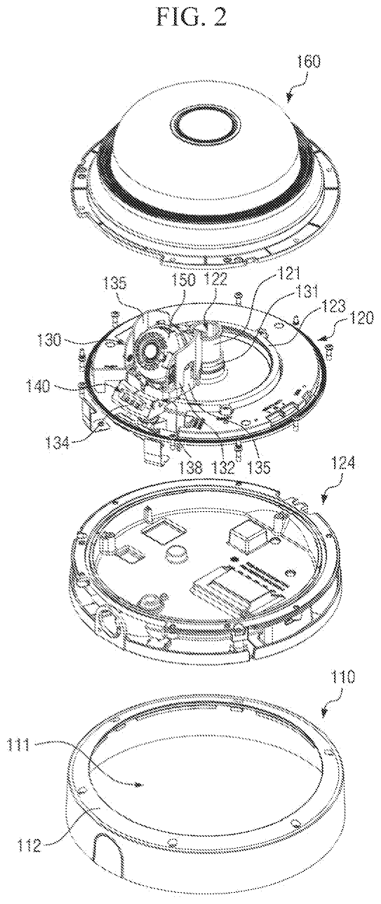

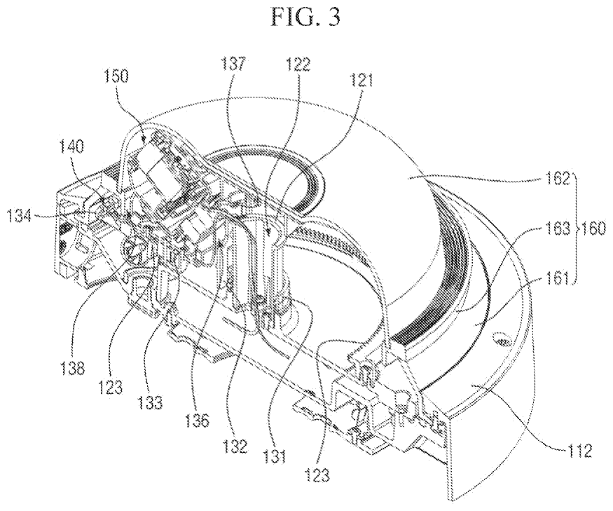

FIG. 1 is a perspective view of a camera 100 to which a dome cover 160 is coupled according to some embodiments of the present disclosure. FIG. 2 is an exploded perspective view of the camera 100 shown in FIG. 1. FIG. 3 is a cross-sectional view of the camera 100 taken along line I-I′ of FIG. 1.

Referring to FIGS. 1 through 3, the camera 100 according to some embodiments of the present disclosure may include a housing 110, a fixed stage 120, a rotation module 130, a light module 140, a camera module 150, and the dome cover 160.

First, the housing 110 may cover a border of the camera 100 approximately along a circumferential direction. The housing 110 may have a set height and may form an accommodation space 111 therein. The housing 110 may have a step 112 formed by a tip end bent inward along the circumferential direction, and the step 112 may be an area to which an outer end of the dome cover 160 to be described later is assembled.

In addition, the fixed stage 120 may be disposed in the accommodating space 111 of the housing 110 to support the installation of the rotation module 130 in an upper area, and a circuit board or the like may be installed in a lower area. The fixed stage 120 may include a hollow cylindrical pillar 121 in a central area, and the pillar 121 may be the center of rotation of the rotation module 130.

Power lines or control signal lines of the camera module 150 and the light module 140 may be connected to the circuit board through a hollow area 122 inside the pillar 121.

The fixed stage 120 may have a ring gear 123 provided along an inner circumferential surface to face the pillar 121. The fixed stage 120 may be fixed on a support frame 124 inside the housing 110, the circuit board may be built into the support frame 124, and the step 112 of the housing 110 may be fixed on an upper end of the support frame 124, together with an outer tip end of the dome cover 160.

In addition, the rotation module 130 may include a clamp 131, a bracket 132, a planetary gear 133, and a mounting portion 134.

The clamp 131 may be coupled to the pillar 121 to cover the pillar 121. For example, in the case of a multi-camera in which a plurality of camera modules 150 are provided, a plurality of clamps 131 may be coupled at different heights on the pillar 121. Although not shown in the drawings, a bearing may be provided inside an area where the clamp 131 and the pillar 121 contact to face each other.

The bracket 132 may be coupled to the clamp 131 and disposed such that it can rotate about the pillar 121. The bracket 132 may be partially bent so that its vertical cross section has an “L” shape, and the camera module 150 may be mounted on the bracket 132. A rotating portion 135 may be provided on the bracket 132 to support the camera module 150 such that the camera module 150 can rotate along a vertical direction. The bracket 132 may have a through hole 136 through which a power line or a control signal line connected to the camera module 150 or the light module 140 can pass.

At the back of the bracket 132 coupled to the clamp 131, a plurality of fastening holes 137 may be formed in a set pattern along the vertical direction to correspond to a coupling height of the clamp 131, so that the clamp 131 can be coupled to the fastening holes 137. For example, the height of the clamp 131 may correspond to a height of the fastening holes 137 of the bracket 132. Therefore, when a second clamp 131 is coupled above a first clamp 131 on the pillar 121, it may be coupled to fastening holes of another bracket 132 spaced upward from the bracket 132 by a height of the first clamp 131.

The planetary gear 133 may be disposed under the bracket 132 to mesh with the ring gear 123 while rotating together with the bracket 132.

The bracket 132 may be supported to be rotatable about the pillar 121 through the clamp 131, but may also be supported in an up-and-down direction through the fixed stage 120 or the ring gear 123.

The mounting portion 134 may be disposed on the outside of the bracket 132 so that the light module 140 can be mounted. Although not shown in the drawings, the bracket 132 may be configured or controlled to rotate only within a set range on the fixed stage 120.

The mounting portion 134 may be disposed at an outer tip end of the bracket 132, and the light module 140 may be installed on the mounting portion 134.

In addition, the bracket 132 may have a shielding groove 138 formed between an area where the camera module 150 is installed and the mounting portion 134 where the light module 140 is installed, so that a portion of the dome cover 160 can be inserted into the shielding groove 138.

In addition, the light module 140 may be disposed at a position corresponding to the camera module 150 along the circumferential direction of the rotation module 130. That is, one light module 140 may be paired with one camera module 150, and one light module 140 and one camera module 150 may be disposed at the same angle with respect to the circumferential direction.

In the case of a multi-camera in which a plurality of light modules 140 and a plurality of camera modules 150 are provided, pairs of the light modules 140 and the camera modules 150 may be disposed at equal angles or equal intervals around the pillar 121, and the light module 140 and the camera module 150 in each pair may be disposed to rotate simultaneously on the rotation module 130.

The light module 140 may irradiate light to the outside and may be disposed adjacent to each camera module 150 so that the irradiated light can sufficiently illuminate a subject. The light irradiated from the light module 140 may be irradiated to the outside through the dome cover 160, reflected from the subject, and then incident on the camera module 150 through the dome cover 160 again.

In addition, the camera module 150 may be mounted on the rotating portion 135 provided on the bracket 132. Therefore, since the camera module 150 is coupled to rotation axes on both sides provided on the rotating portion 135, tilt motion is possible along the up-and-down direction, and pan motion is possible according to the circumferential rotation of the rotation module 130. Although not shown in the drawings, the camera module 150 may additionally have a self-rotating motion or zooming function by rotating about an optical axis (an axis perpendicular to the center of each lens).

Although a case where an infrared camera is applied to the camera module 150 and an infrared light-emitting diode (LED) is applied to the light module 140 is described as an example embodiment, the present disclosure is not limited thereto, and a camera module and a light module using a visible light camera and a visible light source or other wavelengths may also be applied. In this sense, the dome cover 160 may be applied such that light of a specific wavelength range used according to a designer's intention can be incident or emitted.

Although not shown in FIGS. 2 and 3, the camera 100 may be equipped with a motor. The motor may rotate the rotating portion 135 about the pillar 121 on the fixed stage 120. At this time, the light module 140 and the camera module 150 may simultaneously rotate about one rotation axis. For example, the motor may be provided in a lower space of the fixed stage 120, and various elements such as the circuit board for controlling the motor may be further provided.

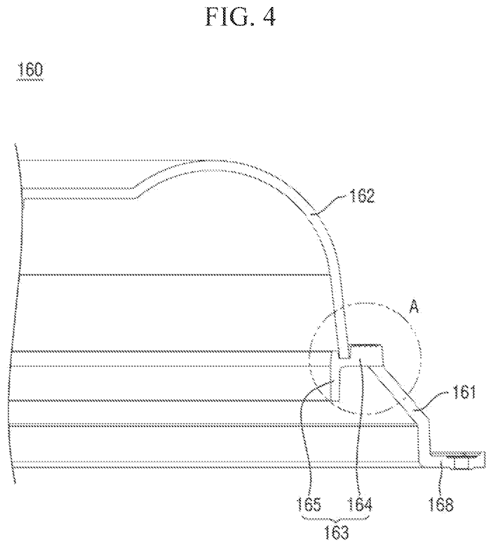

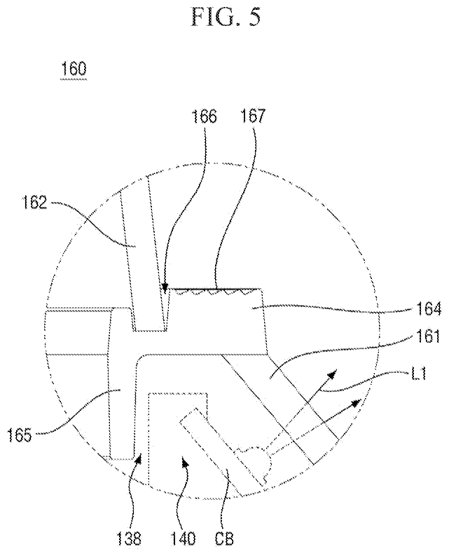

FIG. 4 is an enlarged cross-sectional view of a portion of the dome cover 160 shown in FIG. 3. FIG. 5 is a partial enlarged view of area A of FIG. 4.

Referring to FIGS. 4 and 5, the dome cover 160 according to the present disclosure may include a light cover 161, a camera cover 162, and a shield 163.

First, the light cover 161 may surround the outside of the light module 140 described above. The light cover 161 may be fastened to a tip end of the housing 110. The light cover 161 may be inclined according to the angle of inclination at which the light module 140 is installed. The light module 140 and the light cover 161 may be spaced apart from each other.

An outer tip end of the light cover 161 may be provided with a flange 168 which is fastened to the inside of the step 112 described above.

In addition, the camera cover 162 may surround the outside of the camera module 150 described above and shield the top of an opening of the housing 110. For example, in the camera cover 162, at least a tilting angle range of the camera module 150 may be formed as a curved surface to correspond to the tilt motion in which the camera module 150 rotates in the up-and-down direction.

In addition, the shield 163 may be interposed between the light cover 161 and the camera cover 162 to attach them from both sides. Here, the camera cover 162 may be attached inside the light cover 161 to the shield 163 along a horizontal direction. The shield 163 can prevent the transmission of light irradiated from the light module 140.

The shield 163 may include a fixing portion 164 and an extension portion 165.

The fixing portion 164 may have the camera cover 162 attached to a first side and the light cover 161 attached to a second side.

A fixing groove 166 may be formed on an inner side of the first side of the fixing portion 164, and a wrinkle pattern 167 may be formed on an outer side.

At least a portion of a tip end of the camera cover 162 may be inserted into the fixing groove 166 and molded to be attached through ultrasonic welding. In other words, the fixing groove 166 may be configured to allow at least a portion of a tip end of the camera cover 162 to be inserted therein.

Ultrasonic welding molding may be a method of heat welding using a piezoelectric effect by converting ultrasonic waves into electrical energy using about 15 to 50 kHz in the range of about 10 kHz to 10 MHz of the ultrasonic waves and converting the electric energy into mechanical vibrations through repetition of contraction and relaxation according to the direction of a voltage.

Although not shown in the drawings, the tip end of the cover 162 may fill the inside of the fixing groove 166 as a portion of the tip end melts in the ultrasonic welding molding process.

Therefore, a sealing function may be provided between the camera cover 162 and the shield 163.

The wrinkle pattern 167 may be formed on an upper surface of the outer side of the first side of the fixing portion 164. The wrinkle pattern 167 may block light L1 irradiated from the light module 140 or light reflected from the light cover 161 from being reflected toward the camera cover 162. Since a combined cross section of the fixing portion 164 and the extension portion 165 is bent in an approximately ‘L’ shape, the shield 163 can basically block the light L1 irradiated from the light module 140 from travelling toward the camera cover 162.

In addition, the extension portion 165 may extend from an inner side of the fixing portion 164 toward an inner area of the light cover 161. In FIG. 5, a lower end of the extension portion 165 may be positioned lower than an upper end of an LED board (circuit board CB) provided in the light module 140.

As shown in FIGS. 2 and 3, the extension portion 165 may be inserted into the shielding groove 138 formed between the area where the camera module 150 is installed and the mounting portion 134 where the light module 140 is installed. Therefore, the extension portion 165 can prevent the light L1 irradiated from the light module 140 from being transmitted to an inner area of the camera cover 162 after being reflected from the inner area of the light cover 161.

In addition, the light cover 161 may be attached adjacent to an outer tip end on the second side of the fixing portion 164 through double injection molding. In the double injection molding, a product can be molded through half a cycle using different resins with different colors. Generally, the double injection molding may be a method of molding by filling a second cavity space with a first molded product and a second resin using an injection molding machine structured to have two injection devices and a rotating mechanism installed on a movable plate or a mold designed to enable double injection using a core or slide structure.

Since two parts can be molded through one molding in the double injection molding, cost reduction and production of products with various designs can be expected.

Here, in the process of forming the dome cover 160, a process of attaching the light cover 161 to the shield 163 through double injection molding or simultaneously molding the light cover 161 and the shield 163 may be performed prior to the process of molding the shield 163 and the camera cover 162 through ultrasonic welding.

The light cover 161 and the camera cover 162 may also be attached to the shield 163 by adhesion.

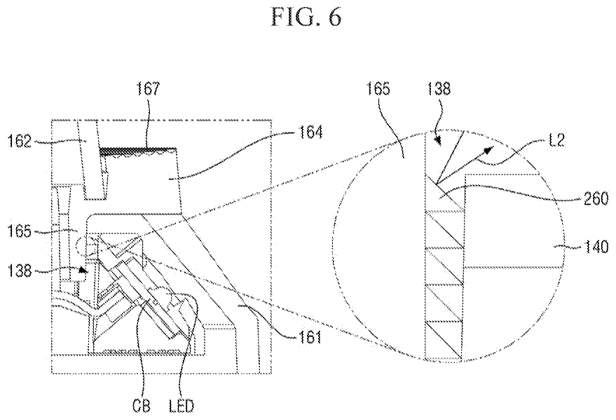

FIG. 6 is a reference diagram of the dome cover 160 according to some embodiments of the present disclosure.

Referring to FIG. 6, a dome cover 160 according to some embodiments of the present disclosure may include a reflection pattern 260 to reflect light, which is reflected from a light module 140 toward a shield 163, back toward a light cover 161.

In FIG. 6, a saw tooth pattern having a constant size and shape is shown as an example of the reflection pattern 260. However, the reflection pattern 260 may also be formed as a sawtooth pattern whose size and shape are not constant. The reflection pattern 260 may also be designed to reflect light, which is reflected toward an outer circumferential surface of an extension portion 165, toward the outside of a shielding groove 138 or toward the light cover 161 by using a flat surface, a curved surface or a combination of the same, in addition to the saw tooth shape.

The reflection pattern 260 may extend such that a protruding tip end corresponds to a width of the shielding groove 138, and its surface that reflects light may be formed as a concave curved surface.

That is, since the shield 163 can reflect light L2, which is reflected toward the shielding groove 138, back toward the light cover 161 through the reflection pattern 260, it brings about the effect of increasing light efficiency and preventing reflected light from entering a camera module 150.

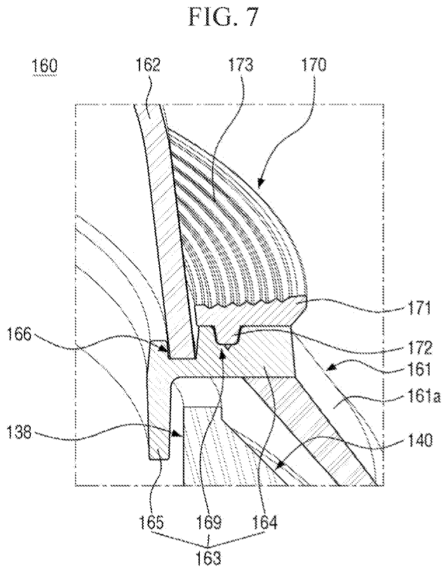

FIG. 7 is a reference diagram of the dome cover 160 according to some embodiments of the present disclosure.

Referring to FIG. 7, a dome cover 160 may include a light cover 161, a camera cover 162, a shield 163, and an eave 170.

Since the structures of the light cover 161 and the camera cover 162 are the same as those of the above-described embodiments, a redundant description thereof will be omitted.

The shield 163 may include a fixing portion 164 and an extension portion 165.

A fixing groove 166 to which the camera cover 162 is attached may be formed on a first side of the fixing portion 164, and a coupling groove 169 to which the eave 170 is attached may be formed outside the fixing groove 166. In addition, the light cover 161 may be attached to a second side of the fixing portion 164.

In addition, the extension portion 165 may extend from an inner tip end of the fixing portion 164 to an inner area of the light cover 161. Since a light module 140 and a camera module 150 (see FIG. 2) are structured to move together, a predetermined space may be required between the camera module 150 and the shield 163, and the extension portion 165 may provide a function of blocking the introduction of light through this space. Therefore, the extension portion 165 may extend into a shielding groove 138 but may be placed not to interfere with the movement of the camera module 150 or the light module 140.

The eave 170 may include a coupling portion 172, a protruding portion 171, and a wrinkle pattern 173.

The coupling portion 172 may protrude from the bottom of the eave 170 to correspond to the coupling groove 169. The coupling portion 172 and the coupling groove 169 may be attached to each other through ultrasonic welding. In FIG. 7, one coupling portion 172 and one coupling groove 169 are provided as an example embodiments. However, a plurality of coupling portions 172 and a plurality of coupling grooves 169 may also be provided.

In addition, the protruding portion 171 may protrude further outward from an outer circumferential surface of the eave 170 than an outer circumferential surface of the fixing portion 164. The protruding portion 171 may be disposed to interfere with an imaginary straight line that connects a light emission surface 161a of the light cover 161 to an outer surface of the camera cover 162. That is, the protruding portion 171 may function as a shade that prevents light emitted from the light emission surface 161a of the light cover 161 from directly entering the camera cover 162. For example, a length by which the protruding portion 171 protrudes from an outer circumferential surface of the shield 163 may correspond to a center height of the eave 170 from an upper surface of the shield 163. However, the protruding portion 171 may protrude to a range that does not interfere with a shooting angle of the camera module 150.

In addition, the wrinkle pattern 173 may protrude from an upper surface of the eave 170 in a set pattern along the circumferential direction. The wrinkle pattern 173 provides the same function and effect as the wrinkle pattern 167 of the above-described embodiment of FIG. 5, and thus a redundant description thereof will be omitted.

The shield 163 may be formed to slope upward so that its height increases from the inside toward the outside. Accordingly, a height of the wrinkle pattern 173 may also increase toward the outside.

Therefore, according to a dome cover and a camera including the same according to some embodiments of the present disclosure, because a process of assembling each of a light cover and a camera cover to a shield is not required, tact time of the manufacturing process can be significantly reduced. In addition, because the dome cover is manufactured through double injection molding or ultrasonic welding molding, a sealing function can be additionally provided. Also, a bracket structure for assembling the camera cover and the light cover is removed, and an assembly area is eliminated. Therefore, miniaturization is possible, and/or space utilization can be increased. A reflection pattern provided on an extension portion of the shield can prevent light irradiated from a light module from being reflected to an internal area of the camera cover member. In addition, an eave provided on the shield can prevent light emitted from the light cover from being incident on the camera cover member.

A dome cover and a camera including the same according to the various embodiment of the present disclosure provide at least one of the following advantages.

First, because a process of assembling each of a light cover and a camera cover to a shield is not required, tack time of the manufacturing process can be significantly reduced.

Second, because the dome cover is manufactured through double injection molding or ultrasonic welding molding, a sealing function can be additionally provided.

Third, a bracket structure for assembling the camera cover and the light cover is removed, and an assembly area is eliminated. Therefore, miniaturization is possible, and/or space utilization can be increased.

Fourth, a reflection pattern provided on an extension portion of the shield can prevent light irradiated from a light module from being reflected to an internal area of the camera cover member.

Fifth, an eave provided on the shield can prevent light emitted from the light cover from being incident on the camera cover member.

However, the effects of the present disclosure are not restricted to the one set forth herein. The above and other effects of the present disclosure will become more apparent to one of daily skill in the art to which the present disclosure pertains by referencing the claims.

While the present disclosure has been particularly shown and described with reference to exemplary embodiments thereof, it will be understood by those of ordinary skill in the art that the present disclosure is not limited to the same configurations and operations as the specific embodiments described above, and various changes in form and detail may be made therein without departing from the spirit and scope of the present disclosure as defined by the following claims. Therefore, the scope of the present disclosure is defined not by the detailed description of the invention but by the following claims, and all differences within the scope will be construed as being included in the present disclosure.

What is claimed is:

1. A dome cover configured to shield an opening of a housing in which at least one camera module and a light module corresponding to the at least one camera module are mounted, the dome cover comprising:
a light cover coupled to the housing and surrounding an outside of the light module;
a camera cover surrounding the outside of the at least one camera module and shielding the opening of the housing; and
a shield interposed between the light cover and the camera cover and configured to prevent transmission of light from the light module,
wherein the light cover and the camera cover are attached to the shielding member.

2. The dome cover of claim 1, wherein the shield comprises:
a fixing portion comprising a fixing groove formed on a first side, the fixing groove being configured to allow at least a portion of a tip end of the camera cover to be inserted therein, and the light cover being attached to a second side of the fixing portion; and
an extension portion extending from an inner circumferential surface of the fixing portion toward an inner area of the light cover member.

3. The dome cover of claim 2, wherein the light cover is molded by double injection and attached to a tip end of the second side of the fixing portion.

4. The dome cover of claim 2, wherein the camera cover is molded by ultrasonic welding and a portion of the camera cover inserted into the fixing groove is attached to the first side of the fixing portion.

5. The dome cover of claim 2, wherein the extension portion comprises a reflection pattern on an outer surface facing an inner circumferential surface of the light cover and is configured to reflect light irradiated from the light module toward the light cover member.

6. The dome cover of claim 2, wherein the shield comprises a winkle pattern on a surface of the first side of the fixing portion.

7. The dome cover of claim 2, wherein the shield comprises an eave protruding from an outer surface of the fixing portion along a circumferential direction.

8. The dome cover of claim 7, wherein an outer circumferential surface of the eave protrudes further outward than an outer circumferential surface of the fixing portion.

9. A dome cover configured to shield an opening of a housing in which at least one camera module and a light module corresponding to the at least one camera module are mounted, the dome cover comprising:
a light cover coupled to the housing and surrounding an outside of the light module;
a camera cover surrounding the outside of the at least one camera module and shielding the opening of the housing;
a shield interposed between the light cover and the camera cover and configured to prevent transmission of light from the light module; and
an eave coupled to the shield and configured to prevent light emitted from the light cover from being incident toward the camera cover member.

10. The dome cover of claim 9, wherein the shield comprises:
a fixing portion comprising a fixing groove and a coupling groove formed on a first side, the light cover being attached to a second side of the fixing portion; and
an extension portion extending from an inner circumferential surface of the fixing portion toward an inner area of the light cover member,
wherein the camera cover is attached to the fixing groove, and the coupling groove, into which the eave is inserted, is formed outside the fixing groove.

11. The dome cover of claim 10, wherein the eave comprises:
a coupling portion protruding from a lower surface of the eave and inserted into the coupling groove;
a wrinkle pattern protruding from an upper surface of the eave in a set pattern along a circumferential direction; and
a protruding portion protruding further outward from an outer circumferential surface of the eave than an outer circumferential surface of the fixing portion.

12. The dome cover of claim 11, wherein the eave slopes upward such that a height of the protruding portion increases from the inside toward the outside.

13. The dome cover of claim 11, wherein the protruding portion is configured to interfere with an imaginary straight line that connects a light emission surface of the light cover to an outer surface of the camera cover member.

14. The dome cover of claim 10, wherein the light cover and the camera cover are attached to both sides of the shielding member.

15. The dome cover of claim 10, wherein the light cover is formed by double injection and attached to a tip end of the second side of the fixing portion.

16. The dome cover of claim 10, wherein a tip end of the camera cover and the fixing groove are attached by ultrasonic welding, and the coupling portion and the coupling groove are attached by ultrasonic welding.

17. The dome cover of claim 10, wherein the camera cover is attached inside the light cover to the shielding member.

18. The dome cover of claim 10, wherein the extension portion comprises a reflection pattern on an outer surface facing an inner circumferential surface of the light cover and is configured to reflect light irradiated from the light module toward the light cover member.

19. A camera comprising:
a fixed stage;
at least one camera module on the fixed stage;
a light module corresponding to the at least one camera module;
a bracket coupled onto the fixed stage and configured to simultaneously rotate the at least one camera module and the light module about one rotation axis; and
a dome cover on the fixed stage and configured to cover the at least one camera module and the light module,
wherein the dome cover comprises:
a light cover surrounding the outside of the light module;
a camera cover surrounding the outside of the at least one camera module;
a shield interposed between the light cover and the camera cover and configured to block light from the light module from being transmitted to the camera cover member; and
an eave coupled to the shield and configured to prevent light emitted from the light cover from being incident toward the camera cover member.

20. The camera of claim 19, wherein the cave comprises a protruding portion protruding further outward than an outer circumferential surface of the shielding member and configured to interfere with an imaginary straight line that connects a light emission surface of the light cover to an outer surface of the camera cover member.
